(19) United States
(12) Patent Application Publication
(10) Pub. No.: US 2002/0191617 A1
(43) Pub. Date: Dec. 19, 2002

(54) System and method for transporting channelized ethernet over SONET/SDH

(76) Inventors: Luc Duplessis, Kirkland (CA); Andre Leroux, Montreal (CA)

Correspondence Address: F. Drexel Feeling, Esq., JONES, DAY, REAVIS & POGUE, North Point, 901 Lakeside Avneue, Cleveland, OH, 44114, US

(21) Appl. No.: 10/164,180

(22) Filed: Jun. 6, 2002

Related U.S. Application Data
(60) Provisional application No. 60/296,432, filed on Jun. 6, 2001.

(51) Int. Cl. H04L 12/28; H04Q 11/00

(52) U.S. Cl. 370/400; 370/395.3; 370/372

(57) ABSTRACT

A system for transporting traffic is provided. The system transports traffic from a first network access path over a transport network path having multiple channels and transports traffic from a second network access path over the same transport network path. The system transports the traffic using transport network path channels wherein the bandwidth of the first network access path is higher than the capacity of any of the transport network path channels and wherein the bandwidth of the second network access path is higher than the capacity of any of the transport network path channels. The system allocates a first quantity of the transport network path channels for transporting traffic from the first network access path. The system allocates a second quantity of the transport network path channels for transporting traffic from the second network access path. And, the sum of the first quantity plus the second quantity is less than or equal to the total number of channels in the transport network path.

### CROSS-REFERENCE TO RELATED APPLICATIONS

This application claims priority from and is related to U.S. Provisional Application No. 60/296,432 entitled “System and Method for Transporting Channelized Ethernet Over SONET/SDH” which was filed on Jun. 6, 2001. The entire disclosure of U.S. Provisional Application No. 60/296,432 is hereby incorporated into the present application by reference.

### BACKGROUND OF THE INVENTION

1. Technical Field

The present invention is generally directed to the field of data communication networks. More specifically, the invention is directed to bandwidth efficient mapping of traffic from one network type into another.

2. Description of the Related Art

The SONET/SDH standards provide for a granularity of an STS-xC pipe (˜150 Mbits/s, x=1,2,3 . . . ). The SONET/SDH equipment on the market, however, support only STS-3c, STS-12c, STS-48c, etc. with their maximum data rates of 155.52 Mbits/s, 622.08 Mbits/s, and 2488.32 Mbits/s, respectively. Depending on the payload size required, it is inefficient to map a payload size of y into x when y<<x. For example, mapping a Gigabit Ethernet port into a SONET/SDH pipe using standard equipment would require the use of an STS-48c channel. STS-3c and STS-12c channels do not have sufficient data rates for Gigabit Ethernet. Consequently, an STS-48c channel would have to be used, and the use of an STS-48c channel would result in ˜40% bandwidth utilization, which is very inefficient.

Virtual Concatenation as specified in ANSI T1.x1.5 has been proposed.

### SUMMARY OF THE INVENTION

A system for transporting traffic is provided. The system transports traffic from a first network access path over a transport network path having multiple channels and transports traffic from a second network access path over the same transport network path. The system transports the traffic using transport network path channels wherein the bandwidth of the first network access path is higher than the capacity of any of the transport network path channels and wherein the bandwidth of the second network access path is higher than the capacity of any of the transport network path channels. The system allocates a first quantity of the transport network path channels for transporting traffic from the first network access path. The system allocates a second quantity of the transport network path channels for transporting traffic from the second network access path. And, the sum of the first quantity plus the second quantity is less than or equal to the total number of channels in the transport network path.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 is a schematic representation of an exemplary communication system that utilizes channelized transport;

FIG. 2 is another schematic representation of an exemplary communication system that utilizes channelized transport;

FIG. 3 is a block diagram of a preferred network element that facilitates channelized transport;

FIG. 4 is a schematic diagram that illustrates channelized transport;

FIG. 5 is a schematic representation of a SONET network that provides channelized transport; and

FIG. 6 is an illustration of an exemplary SONET frame structure when SONET is used for channelized transport.

### DETAILED DESCRIPTION

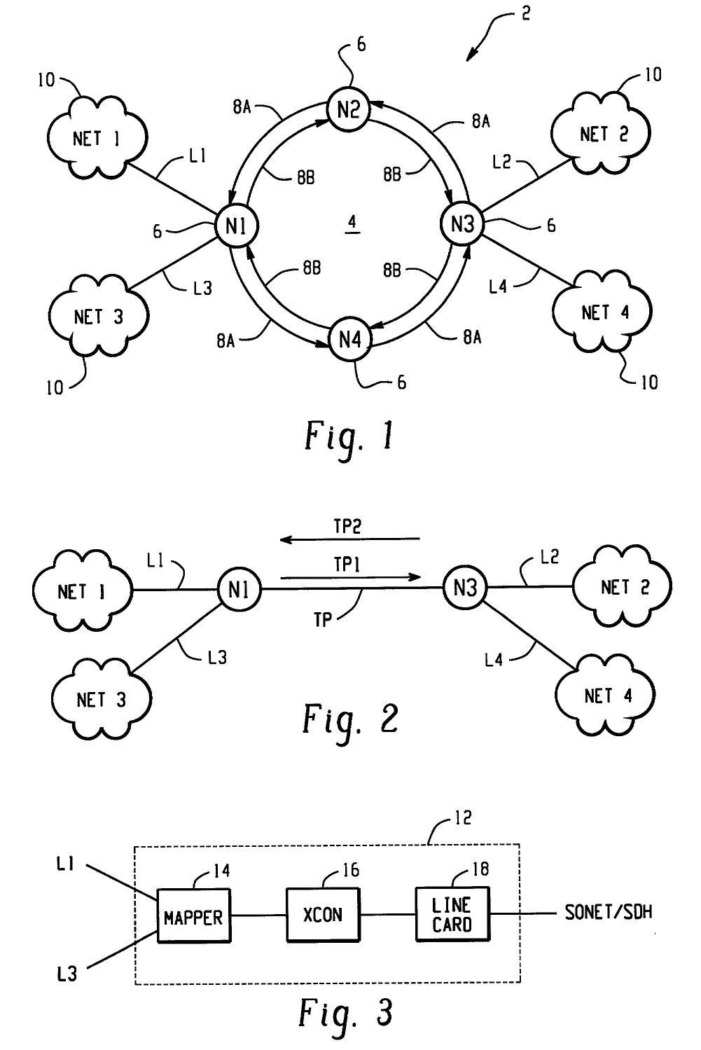

FIG. 1 sets forth a schematic drawing of an exemplary communication system 2 wherein a plurality of network systems are provided with communication paths to other network systems via a transport network. In the embodiment shown, a transport network 4 is provided that includes a plurality of network elements 6, labeled N1-N4, coupled in a ring structures by one or more communication paths 8A, 8B. The transport network 4 is preferably a SONET/SDH network, although other types of transport networks could be used. As shown in FIG. 1, the two paths 8A, 8B transport a plurality of SONET STS-N data streams in opposite directions about the SONET ring 4. The communication paths 8A, 8B are preferably fiber optic connections (in SONET and SDH), but could, alternatively be electrical paths or even wireless connections (in other types of networks). In the case of a fiber optic connection, paths 8A, 8B could be implemented on a single fiber 8, on dual fibers 8A, 8B, or some other combination of connections. In the dual fiber implementation, one of the fibers could be the working ring, and the other fiber could be the protection ring.

The communication paths 8A, 8B comprise one or more transport network paths for transporting data from one node 6 to another node 6 in the network. The transport network 4 in this example is only capable of providing STS-1 transport paths, STS-3c transport paths, STS-12c transport paths, or STS-48c transport paths.

In the ring 4, each network element 6 is preferably coupled to two other network elements 6 in the ring structure. For example, network element N2 is coupled to network elements N1 and N3. The coupling between the elements is two-way, meaning that each element transmits and receives signals to and from each of the two other elements 6 to which it is connected. Each network element 6 includes at least two transmitter/receiver interfaces, one for each connection to another element 6. The network elements 6 could be many types of well-known network devices, such as an add/drop multiplex (“ADM”), switch, router, a SMA, a Marconi MCN-7000 network element, an Access hub, an ATM/IP switch, or other types of devices.

The network devices 6 are preferably ADMs. An ADM is a device having an upstream network element interface, a downstream network element interface, and an add/drop interface. These ADMs 6 are coupled to local elements 10 via network access paths L1-L4, and are used to add signals to the network data traffic from the local elements 10 and, conversely, to drop data signals from the network data traffic to the local elements 10. The switching, adding and dropping operations of the ADM 6 are typically performed by one or more hardware cross-connect switching system cards having one or more hardware cross connect switching matrices. For more information on SONET/SDH formats, line-speeds, and theory of operation, see John Bellamy, Digital Telephony, 2d Edition (1991), pp. 403-425.

As shown in FIGS. 1 and 2, network element N1 is coupled to two network systems Net1 and Net3, via network access paths L1 and L3, respectively. Also, network element N3 is coupled to two network systems, Net2 and Net4, via network access paths L2 and L4, respectively. In the example illustrated by FIG. 2, the transport network 4 provides a transport network path TP between network systems Net1 and Net2 and a transport network path TP between network systems Net3 and Net4. In the example of FIGS. 1 and 2, each of the network access paths L1-L4 are Gigabit Ethernet paths. Because the transport network 4 in this example is only capable of providing STS-1 transport paths, STS-3c transport paths, STS-12c transport paths, or STS-48c transport paths, to provide a transport network path TP between network systems Net1 and Net2, the transport network must dedicate an STS-48c path. Moreover, to provide a transport network path between network systems Net3 and Net4, the transport network must dedicate a STS-48c path. Also, in this example, the network systems Net1, Net2, Net3, and Net4 could be local area networks (LANs), metro area networks (MANs), wide area networks (WANs) or other type of Ethernet equipment or network.

FIG. 3 is a block diagram of a preferred network element 12 that is capable of allowing the communication path between network systems Net1 and Net2 and the communication path between network systems Net3 and Net4 to share transport network path bandwidth thereby more efficiently utilizing the transport network bandwidth. The preferred network element 12 comprises a mapper module 14, a cross-connect module 16, and a line card 18.

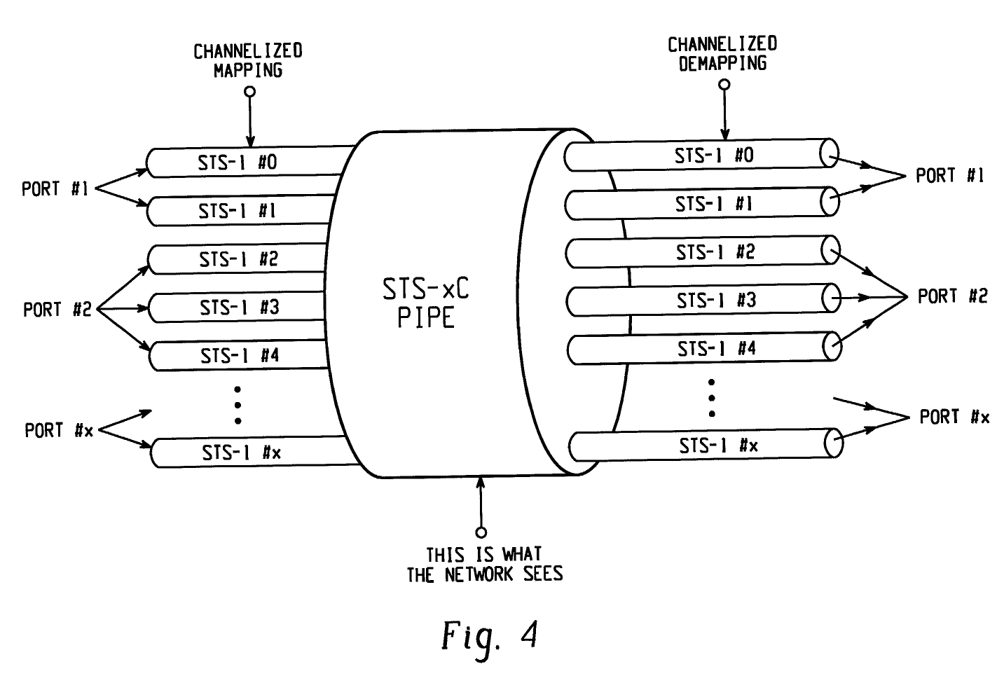

With reference to FIG. 4, preferred network elements N1 and N3 view an STS-48c transport network path as 48 STS-1 transport network path channels, and the other network elements view the STS-48c transport network path as being one STS-48c path. The preferred network elements N1 and N3 use distinct STS-1 portions of the STS-48c to form a bigger payload envelope than the payload envelope for an individual STS-1 channel. The mapper module 14 in the preferred network element 12 maps a traffic port such as an Ethernet port onto the STS-48c. The mapper module 14 chooses a sufficient number of STS-1 channels to complete the mapping. The remaining STS-1 channels are available for mapping other traffic ports onto the STS-48c so that a more efficient use of the STS-48c is made. In the example of FIG. 4, the port #1 is mapped into the first two STS-1 channels, the second port into the STS-1 channel numbers 2, 3 & 4, and so on. The number of STS-1 channels allocated to a port is not fixed but is determined by the needed bit rate for transporting traffic from that port.

The mapper module 14 in the preferred network element 12 preferably performs both a mapping function and a de-mapping function. For traffic flowing from network system Net1 to network system Net2, for example, the mapper module 14 at network element N1 would map traffic from network access path L1 onto STS-1 channels of the STS-48c transport network path. For traffic flowing from network system Net2 to network system Net1, the mapper module 14 at network element N1 would de-map traffic from STS-1 channels of the STS-48c transport network path to network access path L1. Similarly, a mapper module 14 would exist at network element N3 to perform similar mapping and de-mapping functions. At the add point in the network, the port to be mapped uses a pre-configured number of STS-1 channels for its mapping. The traffic to be mapped is distributed among the different STS-1. At the drop point in the network, the STS-1 channels used to map the traffic are de-mapped to re-build the original payload.

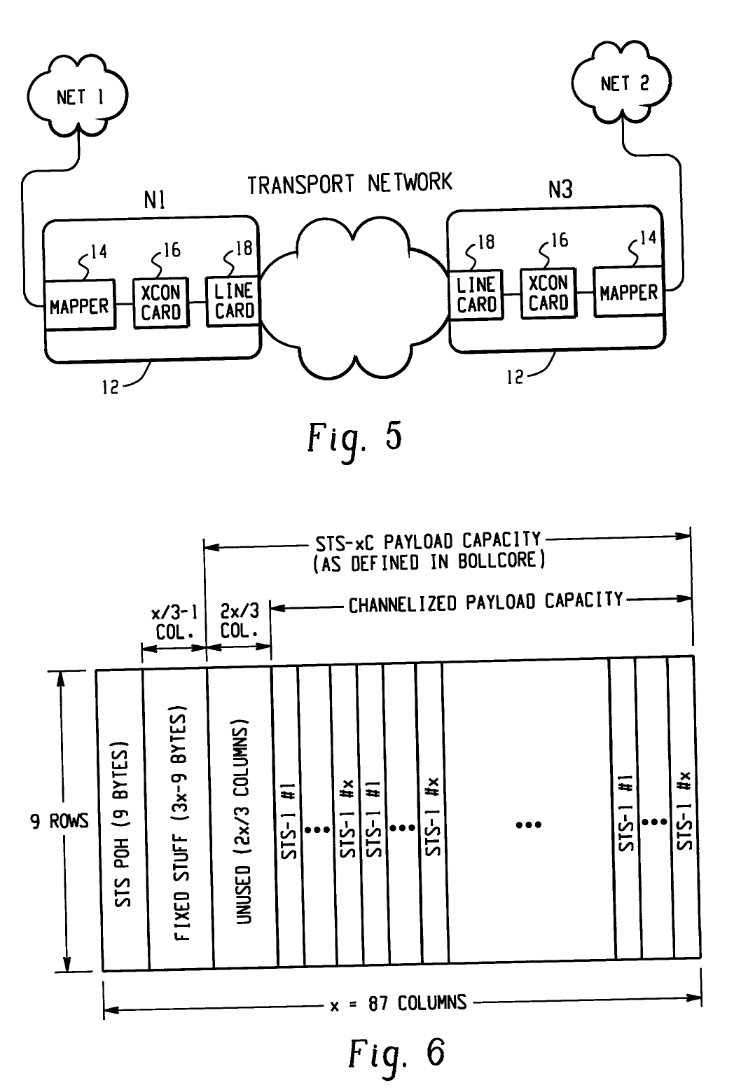

As illustrated in FIG. 5, cross-connect modules 16 at network elements N1 and N3 would perform the add/drop function for the network element, and line cards 18 at network elements N1 and N3 would interface with the communication paths 8A, 8B in the transport network.

In the example of FIGS. 1 and 2, two Gigabit Ethernet ports can be mapped into a single STS-48c path. The 24 first STS-1 channels would be used to transport the first Gigabit Ethernet port and the last 24 STS-1 channels would be used for transporting the second port. Therefore, traffic from network system Net1 to network system Net2 would be mapped onto the first 24 STS-1 channels of transport network path TP and traffic from network system Net3 to network system Net4 would be mapped onto the last 24 STS-1 channels in the STS-48c transport network path TP. In another example, two Fast Ethernet ports can be mapped into an STS-3c transport network path. The first port could be mapped in the first STS-1 channel and the second into the last two STS-1 channels of the transport network path TP.

Exemplary Mapper

The mapper module preferably comprises network access path circuitry. The network access path circuitry receives traffic from the network access path and maps the received traffic onto a number of the network path channels. In the example of FIGS. 1 and 2, the network access path circuitry of the mapper module interfaces with a network access path such as network access path L1 and maps traffic from the network access path L1 onto 24 STS-1 channels of the STS-48c transport network path TP1 from network system Net1 to network system Net2. The network access path circuitry of the mapper module also receives traffic from 24 STS-1 channels of the STS-48c transport network path TP2 from network system Net2 to network system Net1, de-maps that traffic, and transmits it on network access path L1. In this example, the transport network path TP is a two-way network path and comprises a one-way transport network path TP1 and a one-way transport network path TP2 wherein each one-way path is an STS-48c path. Also, in this example, each STS-1 channel is a two-way channel having a one-way channel in the one-way transport network path TP1 and a one-way channel in the one-way transport network path TP2 wherein each one-way channel is a STS-1 channel.

The mapper module preferably comprises at least one additional network access path circuitry. In the example of FIGS. 1 and 2, the second network access path circuitry receives traffic from network access path L2 and maps traffic from the network access path L2 onto the last 24 STS-1 channels of the STS-48c transport network path TP1 from network system Net3 to network system Net4. The second network access path circuitry of the mapper module also receives traffic from the last 24 STS-1 channels of the STS-48c transport network path TP2 from network system Net4 to network system Net3, de-maps that traffic, and transmits it on network access path L2.

The exemplary mapper preferably performs its mapping function, channelized mapping, by using the payload capacity of the smallest high order signal in the transport network path. In the case of SONET, the mapper uses the payload capacity of STS-1 signals to carry traffic from a network system or network access path with traffic such as Ethernet traffic. The Ethernet traffic is organized into a concatenated payload. The concatenated payload is divided into “y” smaller chunks wherein each chunk is small enough to fit within the STS-1 payload of an STS-1 pipe. “Y” STS-1 pipes are used to map the Ethernet traffic. Therefore, to map the Ethernet traffic into the transport network path, the transport network path is divided into “x” STS-1 pipes. “Y” of these STS-1 pipes are considered one payload. The “new” payload formed by the “y” STS-1 pipes is used to map the Ethernet traffic onto the transport network path. The remaining STS-1 pipes within the transport network path (i.e., x-y STS-1 pipes) can be mapped with other payload. At the drop point for the mapped traffic, a mapper would de-map the “y” STS-1 pipes to re-form the Ethernet traffic.

Exemplary Frame Structure

Illustrated in FIG. 6 is an exemplary SONET frame structure for use in SONET channelized mapping. BellCore specifies that there are 3 different portions in the frame structure: the path overhead (“POH”); the fixed stuff; and the STS-xC Payload Capacity. When used for channelized mapping, the STS-xC Payload Capacity is divided into two different portions: unused columns and channelized payload.

The unused columns are not used, preferably filled with all ‘1s’, and are present to make the number of columns divisible by x. The remainder of the channelized payload is divided into x emulated STS-1 channels. The first channelized payload column is for the emulated STS-1 channel #1, the second channelized payload column is for the emulated STS-1 channel #2 and the next channelized payload column is for the next emulated STS-1 channel number and so forth. After the x^{th} channelized payload column is reached, the pattern is repeated and results in the same number of columns for each emulated STS-1 channel.

Conclusion

Other variations from these systems and methods should become apparent to one of ordinary skill in the art without departing from the scope of the invention defined by the claims. The preferred embodiments have been described with reference to SONET/SDH transport networks and Ethernet but the invention described by the claims could be applicable to other network systems.

The embodiments described herein and shown in the drawings are examples of structures, systems or methods having elements corresponding to the elements of the invention recited in the claims. This written description and drawings may enable those skilled in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences from the literal language of the claims. It is also to be understood that the invention is not limited to use with SONET or SDH systems or Ethernet unless explicitly limited by the claims.

The following is claimed:

1. A system for transporting traffic from a first network access path over a transport network path having multiple channels and for transporting traffic from a second network access path over the transport network path, wherein the bandwidth of the first network access path is higher than the capacity of any of the transport network path channels and wherein the bandwidth of the second network access path is higher than the capacity of any of the transport network path channels, the steps performed by the system comprising:
allocating a first quantity of the transport network path channels for transporting traffic from the first network access path; and
allocating a second quantity of the transport network path channels for transporting traffic from the second network access path;
wherein the sum of the first quantity plus the second quantity is less than or equal to the total number of channels in the transport network path.

2. The system of claim 1 wherein the first network access path is an Ethernet path, the second network access path is an Ethernet path, and the transport network path is a SONET or SDH path.

3. The system according to claim 1 wherein the transport network paths are two-way transport network paths and the transport network path channels are two-way transport network path channels.

4. The system according to claim 3 wherein the system comprises a mapper module, the mapper module comprising first network access path circuitry and second network access path circuitry, the first network access path circuitry being operative to receive traffic from the first network access path and to map the received traffic onto the first quantity of transport network path channels, the first network access path circuitry also being operative to receive traffic from the first quantity of network path channels and to transmit the received traffic onto the first network access path, the second network access path circuitry being operative to receive traffic from the second network access path and to map the received traffic onto the second quantity of transport network path channels, and the second network access path circuitry also being operative to receive traffic from the second quantity of network path channels and to transmit the received traffic to the second network access path.

5. The system of claim 4 wherein the mapper module is operable to divide the traffic from the first network access path into “y” sub-units of traffic wherein the bandwidth of one sub-unit is less than or equal to the payload capacity of one transport network path channel, the mapper module also be operable to map each “y” sub-unit into one of the transport network path channels.

6. The system of claim 4 wherein the first network access path is an Ethernet path, the second network access path is an Ethernet path, and the transport network path is a SONET or SDH path.

7. The system of claim 6 wherein the first network access path is a Gigabit Ethernet path, the second network access path is a Gigabit Ethernet path, the transport network path is a SONET STS-48c or SDH STM-12 path, and the transport network path channels are STS-1 or STM-1 channels.

8. The system of claim 4 further comprising a cross-connect device, the cross-connect device being operative to switch traffic from the first network access path circuitry to the first quantity of transport network path channels and to switch traffic from the first quantity of transport network path channels to the first network access path circuitry, the cross-connect device also being operative to switch traffic from the second network access path circuitry to the second quantity of transport network path channels and to switch traffic from the second quantity of transport network path channels to the second network access path circuitry.

9. A system for providing communication between a first network system and a second network system and for providing communication between a third network system to a fourth network system using a two-way transport network path in a transport network wherein the two-way transport network path has multiple two-way channels, the communication bandwidth between the first network system and the second network system being higher than the capacity of any of the transport network path channels and the communication bandwidth between the third network system and the fourth network system being higher than the capacity of any of the transport network path channels, the steps performed by the system comprising:
allocating a first quantity of the transport network path channels for providing communication between the first network system and the second network system; and
allocating a second quantity of the transport network path channels for providing communication between the third network system and the fourth network system;
wherein the sum of the first quantity plus the second quantity is less than or equal to the total number of channels in the transport network path.

10. The system according to claim 9 wherein the system comprises a mapper interface, the mapper interface comprising first network access path circuitry and second network access path circuitry, the first network access path circuitry being operative to receive traffic from the first network system and to map the received traffic onto the first quantity of transport network path channels, the first network access path circuitry also being operative to receive traffic from the first quantity of network path channels and to transmit the received traffic to the first network system, the second network access path circuitry being operative to receive traffic from the second network system and to map the received traffic onto the second quantity of transport network path channels, and the second network access path circuitry also being operative to receive traffic from the second quantity of network path channels and to transmit the received traffic to the second network system.

11. The system of claim 10 wherein the mapper module is operable to divide the traffic from the first network access path into “y” sub-units of traffic wherein the bandwidth of one sub-unit is less than or equal to the payload capacity of one transport network path channel, the mapper module also be operable to map each “y” sub-unit into one of the transport network path channels.

12. The system of claims 10 further comprising a cross-connect device, the cross-connect device being operative to switch traffic from the first network access path circuitry to the first quantity of transport network path channels and to switch traffic from the first quantity of transport network path channels to the first network access path circuitry, the cross-connect device also being operative to switch traffic from the second network access path circuitry to the second quantity of transport network path channels and to switch traffic from the second quantity of transport network path channels to the second network access path circuitry.
